(19) United States
(12) Patent Application Publication
(10) Pub. No.: US 2025/0116373 A1
(43) Pub. Date: Apr. 10, 2025

(54) BRACKET AND ASSEMBLING METHOD

(71) Applicant: Wistron NeWeb Corporation, Hsinchu (TW)

(72) Inventor: Chih Hsiang CHEN, Hsinchu (TW)

(21) Appl. No.: 18/906,464

(22) Filed: Oct. 4, 2024

(30) Foreign Application Priority Data
Oct. 6, 2023 (TW) 112138419

(51) Int. Cl. F16M 13/02

(52) U.S. Cl. CPC F16M 13/02

(57) ABSTRACT

A bracket includes a first unit and a second unit. The first unit includes a first body portion and a first assembling portion connected to the first body portion, and an angle is formed between the first body portion and the first assembling portion. The second unit is pivotally connected to the first unit and includes a second body portion and a second assembling portion. The second assembling portion is connected to the second body portion, and another angle is formed between the second body portion and the second assembling portion. When the first unit and the second unit are in s closed state, the first assembling portion and the second assembling portion are configured for assembling an object.

### RELATED APPLICATIONS

This application claims the benefit of priority to Taiwan Patent Application No. 112138419, filed on Oct. 6, 2023. The entire content of the above identified application is incorporated herein by reference.

### BACKGROUND

### Technical Field

The present disclosure relates to a bracket and an assembling method, and more particularly to a bracket including a first unit and a second unit that are pivotally connected to each other, and an assembling method applying such bracket.

### Description of Related Art

As humans pursue a convenient lifestyle, various electronic products, daily necessities, and architectural accessories have been developed. This means the need to develop more styles and sizes of brackets to conveniently and securely assemble these various electronic products and daily necessities onto architectural accessories.

In view of this, the development of a bracket that can support multiple styles and sizes of electronic products, daily necessities, or architectural accessories, and can be installed through a convenient and stable assembling method is in dire need for the market.

### SUMMARY

According to one aspect of the present disclosure, a bracket includes a first unit and a second unit. The first unit includes a first body portion and a first assembling portion. The first assembling portion is connected to the first body portion. An angle is formed between the first body portion and the first assembling portion. The second unit is pivotally connected to the first unit and includes a second body portion and a second assembling portion. The second assembling portion is connected to the second body portion. Another angle is formed between the second body portion and the second assembling portion. When the first unit and the second unit are in a closed state, the first assembling portion and the second assembling portion are configured to assemble with an object

According to another aspect of the present disclosure, an assembling method for assembling a bracket to an object includes a bracket providing step, a bracket unfolding step, an object coupling step, and a bracket closing step. The bracket providing step includes providing a bracket, which includes a first unit and a second unit, with one end of the first unit and one end of the second unit pivotally connected and having a pivot axis. The bracket unfolding step includes causing the first unit and the second unit to rotate relative to each other about the pivot axis to unfold the first unit and the second unit. The object coupling step includes coupling the first assembling portion of the first unit and a first coupling portion of the object. The bracket closing step includes causing the first unit and the second unit to rotate relative to each other about the pivot axis to close the first unit and the second unit, and simultaneously coupling a second assembling portion of the second unit and a second coupling portion of the object to assemble the object and the bracket.

### BRIEF DESCRIPTION OF THE DRAWINGS

The present disclosure can be more fully understood by reading the following detailed description of the embodiment, with reference made to the accompanying drawings as follows:

FIG. 1 is a three-dimensional view of a bracket according to a first embodiment of the present disclosure.

FIG. 2 is a front view of the bracket shown in FIG. 1.

FIG. 3 is a schematic view of the bracket shown in FIG. 1 in an unfolded state.

FIG. 4 is a flowchart of an assembling method according to a second embodiment of the present disclosure.

FIG. 5 is a schematic view of an object coupling step in the assembling method according to the second embodiment.

FIG. 6 is a schematic view of a bracket closing step in the assembling method according to the second embodiment.

FIG. 7 is a schematic view of an article coupling step in the assembling method according to the second embodiment.

FIG. 8 is a schematic view of a bracket implementation in the assembling method according to the second embodiment.

FIG. 9 is a schematic view of another bracket implementation in the assembling method according to the second embodiment.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

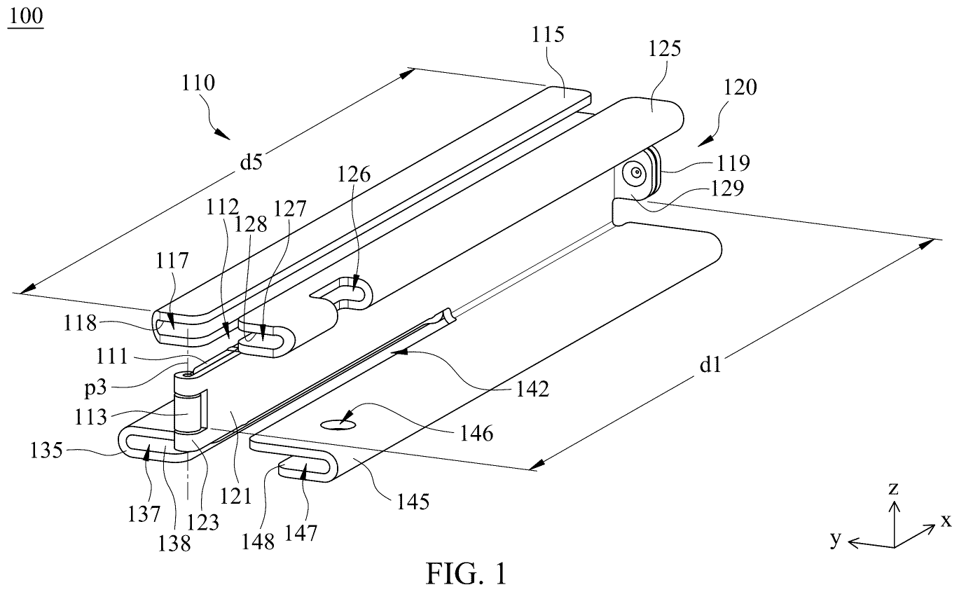

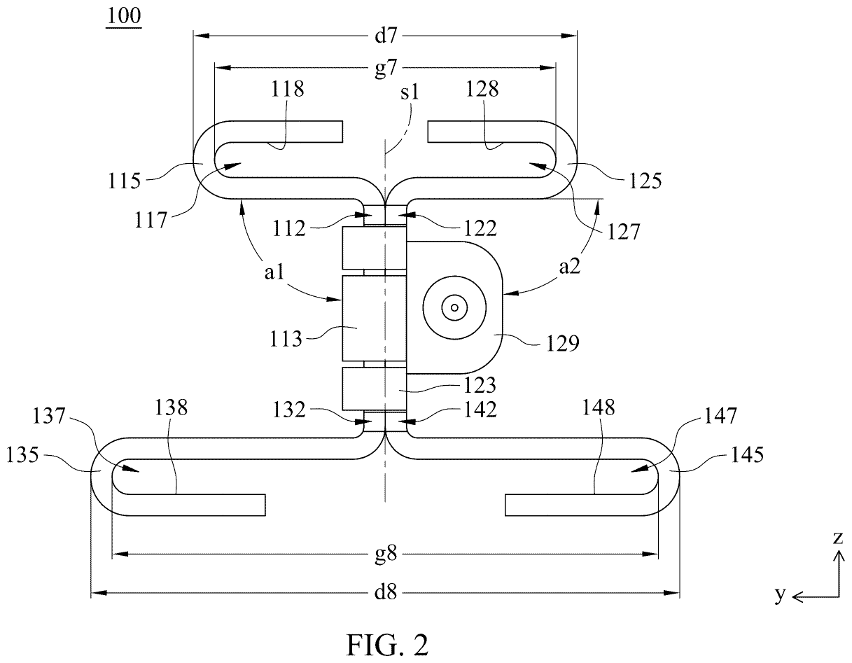

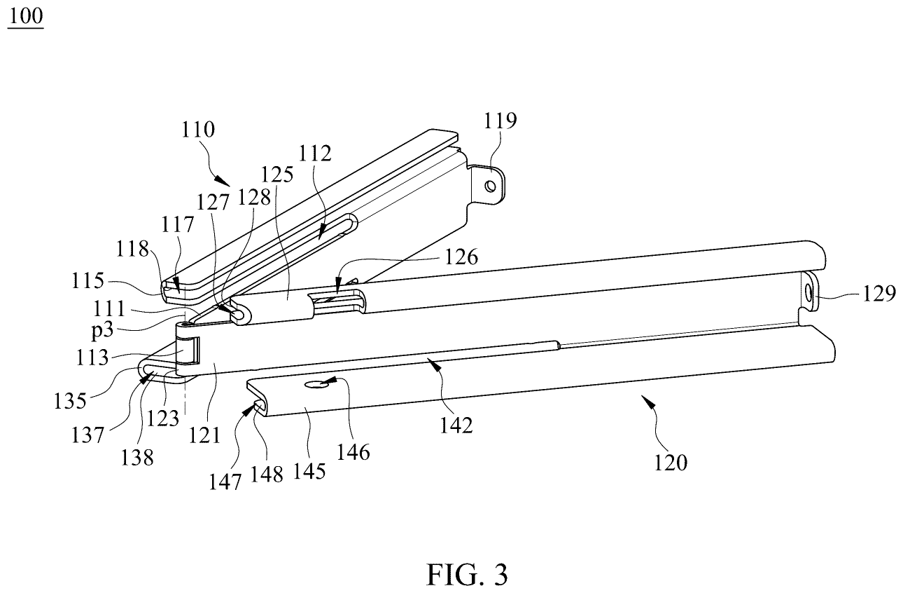

FIG. 1 is a three-dimensional view of a bracket 100 according to a first embodiment of the present disclosure, which is also a schematic view of the bracket 100 in a closed state. FIG. 2 is a front view of the bracket 100 shown in FIG. 1, and FIG. 3 is a schematic view of the bracket 100 shown in FIG. 1 in an unfolded state. Please refer to FIG. 1 to FIG. 3, the bracket 100 includes a first unit 110 and a second unit 120. The first unit 110 includes a first body portion 111 and a first assembling portion 115. The first assembling portion 115 is connected to the first body portion 111, and an angle a1 is formed between the first body portion 111 and the first assembling portion 115. The second unit 120 is pivotally connected to the first unit 110 and includes a second body portion 121 and a second assembling portion 125. The second assembling portion 125 is connected to the second body portion 121, and an angle a2 is formed between the second body portion 121 and the second assembling portion 125. When the first unit 110 and the second unit 120 are in the closed state (as shown in FIG. 1), the first assembling portion 115 and the second assembling portion 125 are configured to assemble with an object. Therefore, when the object is connected to the ceiling, the bracket 100 can be conveniently installed on the object and the installation stability can be enhanced. Furthermore, according to the bracket of the present disclosure, depending on the relative position between the bracket and the object, as well as the design of the first assembling portion and the second assembling portion, the first assembling portion and the second assembling portion can cooperate with each other or independently assemble with the object through fitting, clamping, being sleeved, bearing, being carried, suspending, being suspended, etc., and are not limited thereto.

Specifically, referring to FIG. 2, a virtual central plane s1 is located between the first body portion 111 and the second body portion 121. When the bracket 100 is in the closed state and the unfolded state, the first body portion 111 and the second body portion 121 can be substantially symmetrical to the virtual central plane s1, and the first assembling portion 115 and the second assembling portion 125 can be substantially symmetrical to the virtual central plane s1. The angles a1, a2 can be equal and between 80 degrees and 100 degrees. As such, the space of the bracket 100 is effectively saved and the goal of supporting various objects is achieved. In the first embodiment, the angles a1, a2 are substantially both 90 degrees.

The first unit 110 may further include a first pivot portion 113, and the second unit 120 may further include a second pivot portion 123. The first unit 110 and the second unit 120 are pivotally connected through the first pivot portion 113 and the second pivot portion 123. As shown in FIG. 1, when the bracket 100 is in the closed state, the first pivot portion 113 is connected to the end of the first body portion 111 in the negative direction of a first direction x, and the second pivot portion 123 is connected to the end of the second body portion 121 in the negative direction of the first direction x. This facilitates the convenience of single-hand operation of the bracket 100.

The first unit 110 may further include a first buckle portion 119, and the second unit 120 may further include a second buckle portion 129. The first unit 110 and the second unit 120 are fixed/locked through the engagement of the first buckle portion 119 and the second buckle portion 129, and the engagement method is not limited to the buckle method shown in the drawings of the present disclosure. As shown in FIG. 1, when the bracket 100 is in the closed state, the first buckle portion 119 is connected to the end of the first body portion 111 in the positive direction of the first direction x, and the second buckle portion 129 is connected to the end of the second body portion 121 in the positive direction of the first direction x. The positions of the first buckle portion 119 and the second buckle portion 129 further enhance the convenience of single-hand operation of the bracket 100.

Referring to FIG. 1, the first assembling portion 115 can be connected to the end of the first body portion 111 in the positive direction of a third direction z and extend toward the positive direction of a second direction y. The second assembling portion 125 can be connected to the end of the second body portion 121 in the positive direction of the third direction z and extend toward the negative direction of the second direction y, and the first direction x, the second direction y, and the third direction z are perpendicular to one another and defined based on when the bracket 100 is in the closed state. Thus, the goal of supporting various objects is effectively achieved.

The length d5 of the first assembling portion 115 along the first direction x can be less than the length d1 of the first body portion 111 along the first direction x. In the first direction x, the first pivot portion 113 and the part of the first body portion 111 connected to the first pivot portion 113 protrude more than the first assembling portion 115. This helps to smooth the pivoting during installation and reduce the weight and volume of the bracket 100.

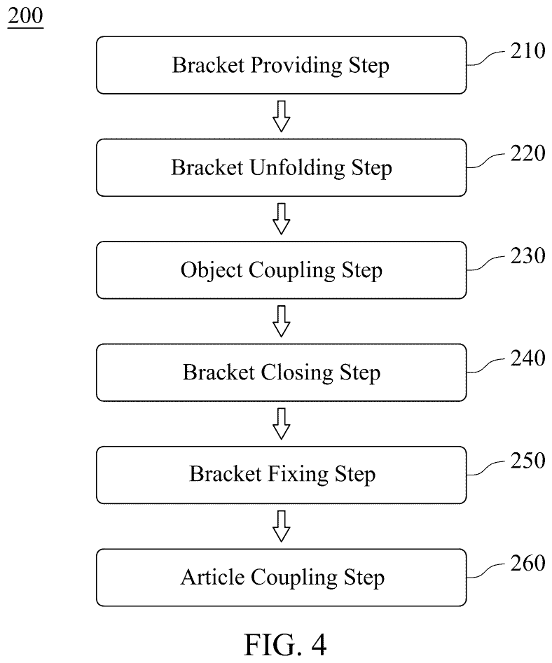

FIG. 4 is a flowchart of an assembling method 200 according to a second embodiment of the present disclosure, and the bracket 100 of the first embodiment and the assembling method 200 of the second embodiment will be described herein together. However, the bracket of the present disclosure is not limited to the operating method of the assembling method 200 of the second embodiment, and the assembling method of the present disclosure is not limited to the application of the bracket 100 of the first embodiment. Specifically, referring to FIG. 1 to FIG. 4, the assembling method 200 is for assembling the bracket 100 to an object 300 and includes a bracket providing step 210, a bracket unfolding step 220, an object coupling step 230, and a bracket closing step 240.

The bracket providing step 210 includes providing the bracket 100, which includes a first unit 110 and a second unit 120, with one end of the first unit 110 and one end of the second unit 120 pivotally connected and having a pivot axis p3, which can be a virtual pivot axis or a physical pivot pin.

Referring to FIG. 3, the bracket unfolding step 220 includes causing the first unit 110 and the second unit 120 to rotate relative to each other about the pivot axis p3 to unfold the first unit 110 and the second unit 120, thus achieving the unfolded state.

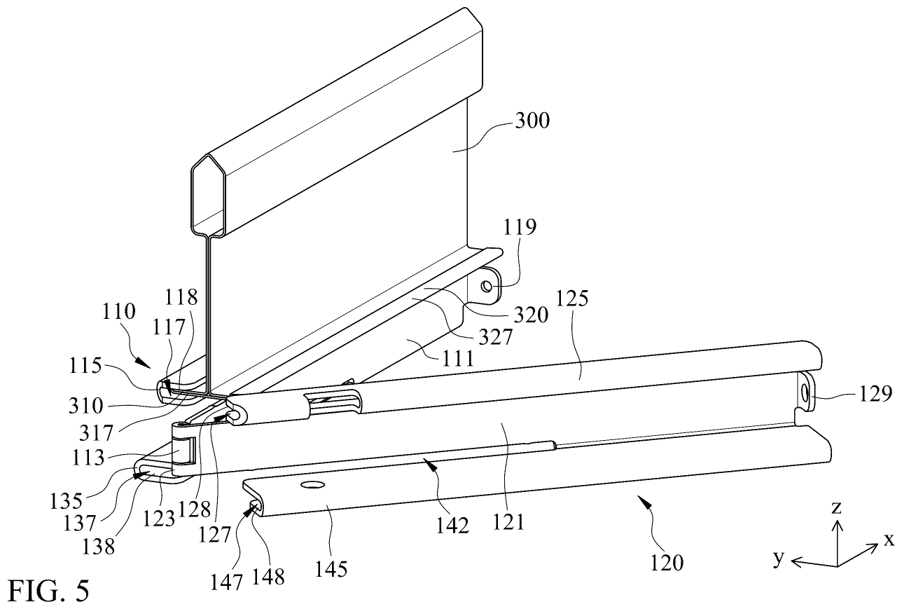

FIG. 5 is a schematic view of the object coupling step 230 in the assembling method 200 according to the second embodiment. Referring to FIG. 5, the object coupling step 230 includes coupling a groove section 117 of the first assembling portion 115 of the first unit 110 and a protrusion section 317 of a first coupling portion 310 of the object 300. Specifically, each of the first unit 110 and the second unit 120 can be made of metal material and integrally formed. The first assembling portion 115 and the first coupling portion 310 can have matching structures. The first assembly portion 115 and the second assembly portion 125 respectively include groove sections 117, 127, which are used to respectively couple with the protrusion sections 317, 327 of the object 300 to cooperatively assemble with the object 300. Thus, when the object 300 is connected to the ceiling, the groove surfaces 118, 128 at the top of the groove sections 117, 127 contact and hang on the protrusion sections 317, 327 of the object 300, which helps to enhance the installation stability of the bracket 100 and reduce safety concerns.

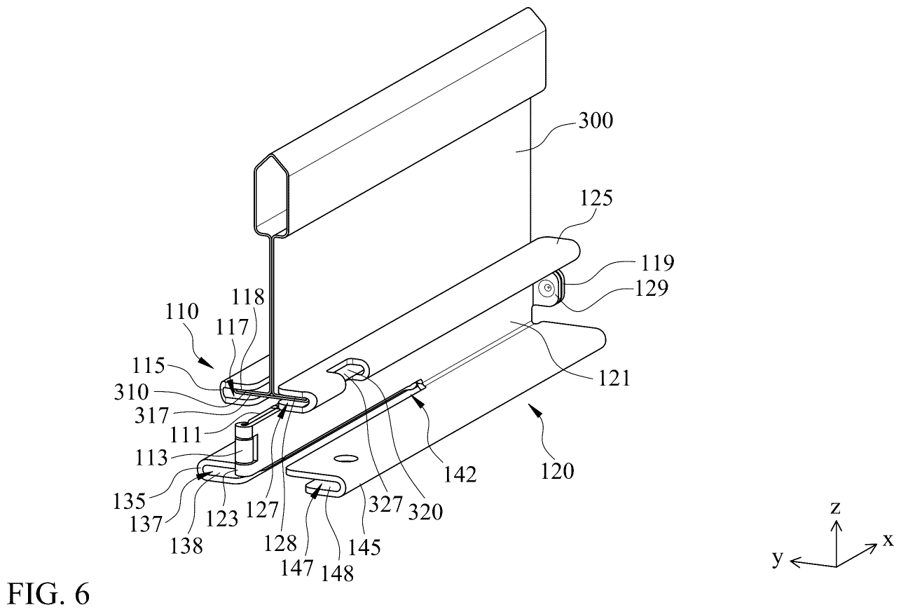

FIG. 6 is a schematic view of the bracket closing step 240 in the assembling method 200 according to the second embodiment. Referring to FIG. 6, the bracket closing step 240 includes causing the first unit 110 and the second unit 120 to rotate relative to each other about the pivot axis p3 to close the first unit 110 and the second unit 120 (i.e., the first unit 110 and the second unit 120 achieve the closed state), and the second assembling portion 125 of the second unit 120 and a second coupling portion 320 of the object 300 are simultaneously coupled to cooperatively assemble the object 300 and the bracket 100. Thus, when the object 300 is connected to the ceiling, the assembling method 200 of the present disclosure helps to conveniently install the bracket 100 onto the object 300 in a rotational manner. The groove surface 118 at the top of the groove section 117 contacts and hangs on the protrusion section 317 of the object 300, and the groove surface 128 at the top of the groove section 127 contacts and hangs on the protrusion section 327 of the object 300, thereby enhancing its installation stability.

In other words, when the first unit 110 and the second unit 120 rotate relative to each other to achieve the unfolded state, the groove section 117 of the first assembling portion 115 is able to couple/engage with the protrusion section 317 of the object 300 (or the groove section 127 of the second assembling portion 125 is able to couple/engage with the protrusion section 327 of the object 300). When the first unit 110 and the second unit 120 subsequently rotate relative to each other to achieve the closed state, the groove section 127 of the second assembling portion 125 is able to couple/engage with the protrusion section 327 of the object 300 (or the groove section 117 of the first assembling portion 115 is able to couple/engage with the protrusion section 317 of the object 300), thus clamping the object 300. Additionally, the bracket 100 of the present disclosure also provides another method for assembling the object 300. When the first unit 110 and the second unit 120 are in the closed state, the protrusion sections 317, 327 of the object 300 can act as sliders that slide into the groove sections 117, 127, respectively, as tracks of the bracket 100, allowing the bracket 100 and the object 300 to be assembled.

The assembling method 200 can further include a bracket fixing step 250, which includes engaging the first buckle portion 119 at the other end of the first unit 110 with the second buckle portion 129 at the other end of the second unit 120 to fix the bracket 100 and secure the object 300 to the bracket 100.

The groove sections 117, 127 of the first assembling portion 115 and the second assembling portion 125 are aligned (having the same length along the first direction x and being of length d5), and the groove section 117 is recessed (concave) along the second direction y toward the positive end, while the groove section 127 is recessed along the second direction y toward the negative end. The first assembling portion 115 and the second assembling portion 125 are configured to clamp the object 300 or to allow another object to sleeve onto them. Thus, when the object is connected to the ceiling, the first assembling portion 115 and the second assembling portion 125 enable the bracket 100 to achieve at least two modes of suspending by the object, such as clamping the object or being sleeved by the object, thereby allowing a single bracket 100 being adaptable to multiple objects.

A gap (slot) 112 can exist between the first body portion 111 and the first assembling portion 115, and a gap 122 can exist between the second body portion 121 and the second assembling portion 125. The gaps 112, 122 are adjacent and can be configured to allow at least a part of the another object to sleeve onto the first assembling portion 115 and the second assembling portion 125 to pass through along the first direction x or the second direction y. This enhances the flexibility of the installation method.

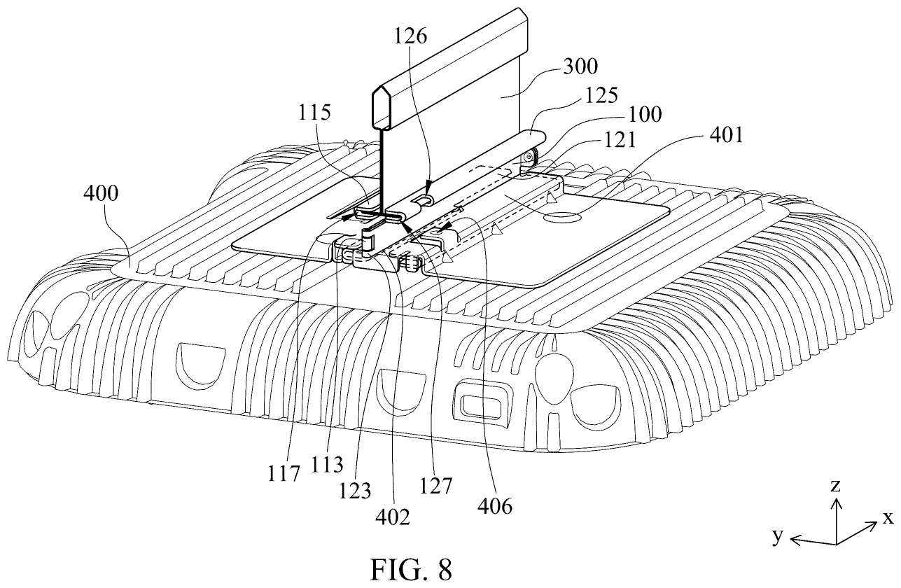

Referring to FIG. 1 to FIG. 3, the first unit 110 can further include a third assembling portion 135, which is connected to the first body portion 111 at the negative end of the third direction z and extends toward the positive direction of the second direction y. The second unit 120 can further include a fourth assembling portion 145, which is connected to the second body portion 121 at the negative end of the third direction z and extends toward the negative direction of the second direction y. The third assembling portion 135 and the fourth assembling portion 145 are configured to support an article (such as the article 400 in FIG. 8). Therefore, when the object 300 is connected to the ceiling, the third assembling portion 135 and the fourth assembling portion 145 enable the bracket 100 to support an article located below it.

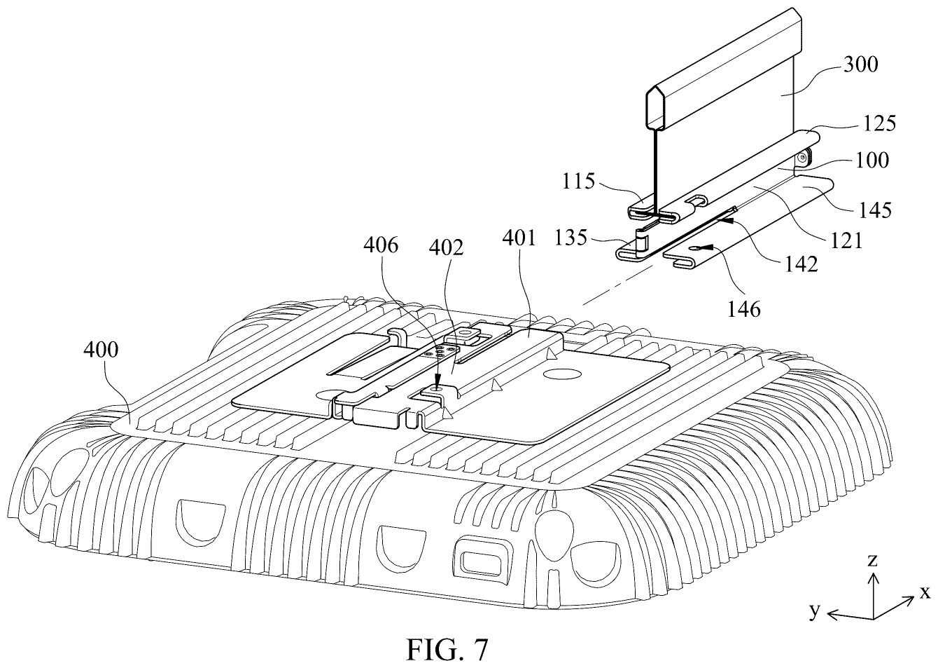

FIG. 7 is a schematic view of the article coupling step 260 in the assembling method 200 according to the second embodiment, and FIG. 8 is a schematic view of a bracket implementation in the assembling method 200 according to the second embodiment. Referring to FIG. 4, FIG. 7 and FIG. 8, the article coupling step 260 includes coupling the third assembling portion 135 of the first unit 110 and the third coupling portion (not labeled) of the article 400, while simultaneously coupling the fourth assembling portion 145 of the second unit 120 and the fourth coupling portion (not labeled) of the article 400. The third assembling portion 135 and the fourth assembling portion 145 are used to allow the article 400 to sleeve onto them. Specifically, each of the third coupling portion and the fourth coupling portion of the article 400 is a part of a sliding groove 401. The protruding third assembling portion 135 and fourth assembling portion 145 of the bracket 100 act as sliders that enter the sliding groove 401 of the article 400, which serves as a track, further allowing the bracket 100 to suspend the article 400 below it. Additionally, a gap 132 exists between the first body portion 111 and the third assembling portion 135, and a gap 142 exists between the second body portion 121 and the fourth assembling portion 145. The gaps 132, 142 are adjacently arranged to allow a part 402 of the article 400 to sleeve onto the third assembling portion 135 and the fourth assembling portion 145 to pass through along the second direction y, so as to fix the article 400 to the lower end (bottom) of the bracket 100. The article 400 can be more securely fixed by screws passing through the opening 146 of the bracket 100 and the opening 406 of the article 400.

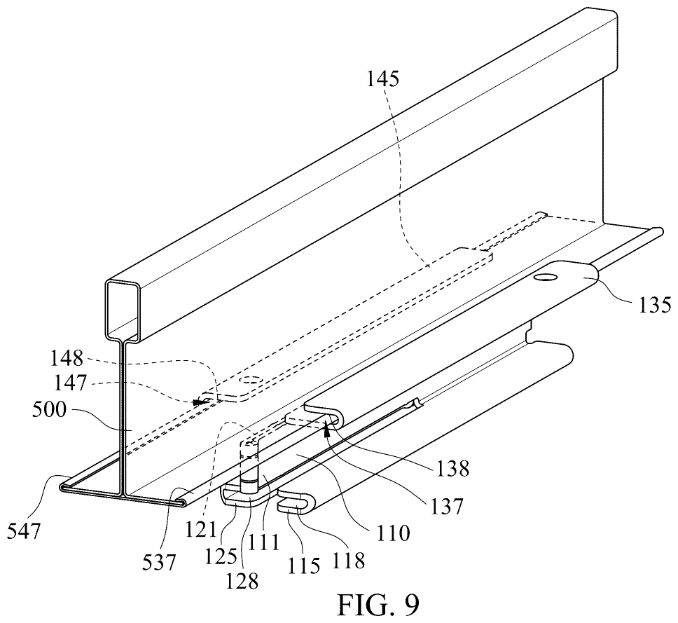

Furthermore, the third assembling portion 135 and the fourth assembling portion 145 can respectively include the groove sections 137, 147, which are aligned (having the same length along the first direction x). The groove section 137 is recessed (concave) along the second direction y toward the positive end, while the groove section 147 is recessed along the second direction y toward the negative end. The third assembling portion 135 and the fourth assembling portion 145 are used to clamp the object (such as the object 500 in FIG. 9) through the groove sections 137, 147. Thus, when the object is connected to the ceiling, the third assembling portion 135 and the fourth assembling portion 145 enable the bracket 100 to further increase the modes of being suspended by the object, such as clamping the object and being sleeved by the object, thereby allowing a single bracket 100 to be adaptable to multiple objects.

Referring to FIG. 2, the total length d7 of the first assembling portion 115 and the second assembling portion 125 along the second direction y is different from and specifically less than the total length d8 of the third assembling portion 135 and the fourth assembling portion 145 along the second direction y. The total recessed depth g7 of the groove sections 117, 127 along the second direction y is different from and specifically less than the total recessed depth g8 of the groove sections 137, 147 along the second direction y. Thus, when an object is connected to the ceiling, it helps the bracket 100 provide at least four options for being suspended by objects of different sizes through clamping or sleeving objects of different sizes at the top in the third direction z.

Referring to FIG. 1 and FIG. 8, the first pivot portion 113 and the second pivot portion 123 have a pivot axis p3, which can be parallel to the third direction z. The third direction z can be perpendicular to the ground, meaning the pivot axis p3 can extend in the direction perpendicular to the ground. Furthermore, the first assembling portion 115 can be located at the upper end or the lower end of the first unit 110, and the second assembling portion 125 can correspond to the first assembling portion 115 and be located at the same end (of the upper end or the lower end) of the second unit 120, while the third assembling portion 135 and the fourth assembling portion 145 are located at the opposite end. This enables the bracket 100 to provide assembling functions at both its upper and lower ends perpendicular to the ground. Additionally, by changing the orientation of the bracket 100, it can also provide assembling functions at its two ends parallel to the ground or inclined to the ground. The opening 146 of the bracket 100 can serve as a screw hole to directly fix it onto the ceiling or wall, and a notch 126 of the bracket 100 facilitates the use of longer screws without interference from the bracket 100 (e.g., the second assembling portion 125).

The first pivot portion 113 and the second pivot portion 123 can be combined to form a hinge structure, and the first assembling portion 115 and the second assembling portion 125 can be configured to assemble the object 300 to the ceiling. This helps in using the third assembling portion 135 and the fourth assembling portion 145 to suspend articles suitable to be indirectly installed to the ceiling, the articles can be the article 400 being an access point (AP) of a wireless communication system, lamps, fans, signboards, decorations, etc., and not limited thereto. When the article 400 is the access point, the object 300 can be a T-bar connected to the ceiling, and the groove sections 117, 127 have matching dimensions to clamp the object 300.

FIG. 9 is the schematic view of another bracket implementation in the assembling method 200 according to the second embodiment. Referring to FIG. 9, when the bracket 100 (in FIG. 9) is disposed upside down (inverted arrangement) relative to the bracket 100 in FIG. 8, the third assembling portion 135 and the fourth assembling portion 145 are used to assemble the object 500, and the object 500 is connected to the ceiling. Therefore, the total lengths d7, d8 of the bracket 100 are different, the total depth g7 of the groove sections 117, 127 and the total depth g8 of the groove sections 137, 147 are different, and by setting the bracket 100 upside down, the bracket 100 can be suspended by objects 300 and 500 of different sizes to connect to the ceiling. Specifically, the groove sections 137, 147 of the third assembling portion 135 and the fourth assembling portion 145 respectively engage with the protrusion sections 537, 547 of the object 500, and the groove surfaces 138, 148 at the top of the groove sections 137, 147 contact and hangs on the protrusion sections 537, 547 of the object 500, clamping the object 500 and being suspended by it. Additionally, the total length of the protrusion sections 537, 547 of the object 500 along the second direction y can be 15/16 inch, and the total length of the protrusion sections 317, 327 of the object 300 along the second direction y can be 9/16 inch.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A bracket, comprising:
a first unit, comprising:
a first body portion; and
a first assembling portion, connected to the first body portion,
wherein an angle is formed between the first body portion and the first assembling portion; and
a second unit, pivotally connected to the first unit and comprising:
a second body portion; and
a second assembling portion, connected to the second body portion, wherein another angle is formed between the second body portion and the second assembling portion;
wherein, when the first unit and the second unit are in a closed state, the first assembling portion and the second assembling portion are configured to assemble with an object.

2. The bracket according to claim 1, wherein the first unit further comprises a first pivot portion, connected to an end of the first body portion in a first direction;
wherein the second unit further comprises a second pivot portion, connected to an end of the second body portion in the first direction, and the first unit and the second unit are pivotally connected through the first pivot portion and the second pivot portion.

3. The bracket according to claim 2, wherein a length of the first assembling portion along the first direction is less than a length of the first body portion along the first direction, and in the first direction, the first pivot portion and a part of the first body portion connected to the first pivot portion protrude more than the first assembling portion.

4. The bracket according to claim 2, wherein the first unit further comprises a first buckle portion, connected to the other end of the first body portion in the first direction;
wherein the second unit further comprises a second buckle portion, connected to the other end of the second body portion in the first direction, and the first unit and the second unit are fixed by engaging the first buckle portion and the second buckle portion.

5. The bracket according to claim 2, wherein the first assembling portion is connected to an end of the first body portion in a third direction and extends toward an end of a second direction, the second assembling portion is connected to an end of the second body portion in the third direction and extends toward the other end of the second direction, and the first direction, the second direction, and the third direction are perpendicular to one another.

6. The bracket according to claim 5, wherein each of the first assembling portion and the second assembling portion comprises a groove section, and the object comprises two protrusion sections;
wherein, when the first unit and the second unit rotate relative to each other to achieve an unfolded state, the groove section of the first assembling portion is able to couple with one of the protrusion sections of the object, and when the first unit and the second unit subsequently rotate relative to each other to achieve the closed state, the groove section of the second assembling portion is able to couple with the other of the protrusion sections of the object, to clamp the object.

7. The bracket according to claim 5, wherein the first unit further comprises a third assembling portion, connected to the other end of the first body portion in the third direction and extends toward the end of the second direction;
wherein the second unit further comprises a fourth assembling portion, connected to the other end of the second body portion in the third direction and extends toward the other end of the second direction, and the third assembling portion and the fourth assembling portion are configured to support an article.

8. The bracket according to claim 7, wherein each of the first assembling portion and the second assembling portion comprises a groove section, the two groove sections are aligned and recessed respectively toward the two ends of the second direction, and the first assembling portion and the second assembling portion are configured to be sleeved by the article thereon or to clamp the object through the two groove sections;
wherein each of the third assembling portion and the fourth assembling portion comprises another groove section, the two another groove sections are aligned and recessed respectively toward the two ends of the second direction, and the third assembling portion and the fourth assembling portion are configured to be sleeved by the object thereon or to clamp another object through the two another groove sections;
wherein a total length of the first assembling portion and the second assembling portion along the second direction is different from a total length of the third assembling portion and the fourth assembling portion along the second direction, and a total recessed depth of the two groove sections along the second direction is different from a total recessed depth of the two another groove sections along the second direction.

9. The bracket according to claim 8, wherein the third direction is perpendicular to a ground, and the object clamped by the first assembling portion and the second assembling portion is connected to a ceiling;
wherein, when the bracket is set upside down, the third assembling portion and the fourth assembling portion are configured to assemble with the another object, and the another object is connected to the ceiling.

10. The bracket according to claim 5, wherein the first pivot portion and the second pivot portion have a pivot axis parallel to the third direction.

11. The bracket according to claim 10, wherein the third direction is perpendicular to a ground.

12. The bracket according to claim 11, wherein the first pivot portion and the second pivot portion are combined to form a hinge structure, and the object configured to assemble with the first assembling portion and the second assembling portion is connected to a ceiling.

13. The bracket according to claim 5, wherein there is a gap between the first body portion and the first assembling portion, there is another gap between the second body portion and the second assembling portion, the gap and the another gap are adjacent and configured to allow at least a part of the object to pass through along the first direction or the second direction.

14. The bracket according to claim 1, wherein each of the first unit and the second unit is made of metal material and integrally formed, and at least one of the first assembling portion and the second assembling portion comprises a groove section configured to couple with a protrusion section of the object to assemble with the object.

15. The bracket according to claim 1, wherein a virtual central plane is located between the first body portion and the second body portion, the first body portion and the second body portion are substantially symmetrical to the virtual central plane, and the first assembling portion and the second assembling portion are substantially symmetrical to the virtual central plane.

16. The bracket according to claim 1, wherein the angle and the another angle are equal and between 80 degrees and 100 degrees.

17. An assembling method, for assembling a bracket to an object, comprising:
a bracket providing step, providing the bracket, which comprises a first unit and a second unit, with one end of the first unit and one end of the second unit pivotally connected and having a pivot axis;
a bracket unfolding step, causing the first unit and the second unit to rotate relative to each other about the pivot axis to unfold the first unit and the second unit;
an object coupling step, coupling a first assembling portion of the first unit and a first coupling portion of the object; and
a bracket closing step, causing the first unit and the second unit to rotate relative to each other about the pivot axis to close the first unit and the second unit, and simultaneously coupling a second assembling portion of the second unit and a second coupling portion of the object to assemble the object and the bracket.

18. The assembling method according to claim 17, wherein each of the first assembling portion and the second assembling portion comprises a groove section, and the two groove sections are configured to couple with two protrusion sections of the first coupling portion and the second coupling portion, respectively, of the object, to clamp the object in the bracket closing step.

19. The assembling method according to claim 17, further comprising:
a bracket fixing step, causing the other end of the first unit and the other end of the second unit to engage, to fix the bracket to the object.

20. The assembling method according to claim 17, wherein the pivot axis extends in a direction perpendicular to a ground, the first assembling portion is located at an upper end or a lower end of the first unit, and the second assembling portion corresponds to the first assembling portion and is located at an end of an upper end and a lower end being same thereas of the second unit.
